(19) United States
(12) Patent Application Publication
(10) Pub. No.: US 2007/0242595 A1
(43) Pub. Date: Oct. 18, 2007

(54) Improved Shaped Digital Media Disks and Method for Manufacturing Same

(76) Inventor: Michele DiCosola, Chicago, IL (US)

Correspondence Address: DENISON & ASSOCS. PC, 212 W. WASHINGTON ST, #2004, CHICAGO, IL, 60606, US

(21) Appl. No.: 11/279,753

(22) Filed: Apr. 14, 2006

(51) Int. Cl. G11B 3/70

(52) U.S. Cl. 369/273; 29/603.01; 206/586

(57) ABSTRACT

A decorative shaped digital computer media disk such as a CD or DVD Rom is provided which may contain either aural and/or video information. It is intended that the media disk may be shaped as an ornament or gift tag for the holidays or special occasions and it may be provided with an aperture in its outer periphery to place a wire or string hanger there through, or it may be shaped in a rectangle to resemble either a business card, a sports trading cord, or even a representative piece from a board game or other computer game. In the case of a sports trading card, the media disk may have the player's image imprinted thereupon and the disk may contain a detailed sports history as well as video and news clips. In the case of a business card, the shaped digital computer media disk may contain advertising and marketing information. It is anticipated that these shaped discs may be molded in the shape of the finished product, or they may be made in a different shape, or even a round form, and then either loser cut, tool cut or die cut and a hanging aperture may be provided in the outer periphery of the disk.

### FIELD OF THE INVENTION

The present invention relates to the field of decorative shaped digital media disks such as CD's and DVD's which may be utilized as gift tags, ornaments or other digitized media which contains visual and/or aural media, and which may be either die cut, tool cut or molded to form a shaped copolymeric disk.

### BACKGROUND OF THE INVENTION

Currently, in the marketplace, there are available a wide variety of CD's and DVD's which may be shaped in various forms and may contain aural and/or visual media. A few of these discs may also be used as ornaments for hanging on a holiday tree. Most prior art disclosure, however, relate to the general area of foldable and plastic containers utilize to ship and store plastic media discs such as CD's and DVD Roms and the like. One patent U.S. Pat. No. 1,541,002 issued to L. Shramek discloses a foldable form for carrying phonographic records in a greeting postcard. U.S. Pat. No. 3,430,761 issued to J. Pelkey discloses the use of a foldable greeting cord and phonographic record contained therein. U.S. Pat. No. 3,595,383 issued to T. Boylon et al. discloses the use of a folding device utilized to hold a plurality of discs. U.S. Pat. No. 5,085,318 issued to K. Leverick discloses the use of a folder to holding, displaying and securing a CD made from card stock, U.S. Pat. No. 5,284,365 issued to J. Stuart discloses the use of a greeting card with a detachable magnetized section that the user can save and attach to a refrigerator.

Other issued patents relating to this field are as follows. U.S. Pat. No. 5,748,608 issued to D. Spector discloses the use of a foldable protective package which opens in book like fashion with a CD secured to one interior portion. U.S. Pat. No. 5,772,019 issued to R. Reed discloses the use of a storage and mailing package for CD's which are secured to one portion thereof. U.S. Pat. No. 5,819,926 issued to O'Brien et al. discloses the use of a method and apparatus for packaging a CD Rom in a three sided container.

Further issued patents relating to the disclosure of CD Rom storage devices include U.S. Pat. No. 6,003,254 issued to Lorber which discloses a CD Rom and greeting card combination which is folded in half but which obscures the shape of the CD Rom contained therein. U.S. Pat. No. 6,273,249 issued to W. Simpson discloses the use of a CD Rom container which is similar to a mailer and not a storage device. U.S. Pat. No. 6,357,584 issued to Simpson also discloses the use of a card device for storing CD's which may also store a VHS tape or audio cassette tape. The carrier device and the tape cartridge are positioned in nested relationship. U.S. Pat. No. 6,453,300 issued to Simpson discloses the use of a method for personalizing a printed greeting card via the internet.

In another related patent disclosure, U.S. Pat. No. 6,494,319 issued to W. Collins discloses the use of a specialized storage device for CD's having a bottom disk retainer panel which optimizes the viewing area of the disk. U.S. Pat. No. Des. 384,210 issued to Menchetti discloses a display card which may hold a CD Rom.

In yet other related patent prior art disclosures are disclosed several different designs for holding compact discs, including U.S. Pat. No. 6,640,969 issued to Darby which discloses the use of a decorative holder wherein the display member may utilize decorative fabric. U.S. Pat. No. 6,288,996 issued to Siegel discloses the use of a specially cut disk which contains ticket and/or pass information and an anti-counterfeit feature. U.S. Pat. No. 6,164,445 issued to Cooper discloses the use of a CD Rom holder which may hold a disk visibly upright and perpendicular to a table or other horizontal surface. Other patent prior disclosures somewhat related to this area include U.S. Pat. No. 6,123,199 issued to Dean which discloses the use of a compact disk holder with resilient material, a hub, felt backing and an adhesive which allows it to be attached to a wall or other vertical surface for storage and/or display. An additional issued patent disclosure is U.S. Pat. No. 5,570,791 issued to Sommi which discloses the use of a wall mounted display holder having a main rigid panel with one or more recesses formed therein for the storage and/or display of CD Roms. In addition, U.S. Pat. No. 5,479,796 issued to Shimano discloses the use of a specialized clear plastic container with an other ring of metal, a chain and a keychain to transform a CD Rom into a fairly complex ornament. Still yet another patent disclosure, U.S. Pat. No. Des. 426,203 issued to Siegel discloses the use of a specially shaped CD Rom having three oval holes in the outer periphery of a media disk. The shape and sizes of the apertures are quite unique and it is not understood if they have any specialized purpose and it is assumed that the shape is purely ornamental in nature.

However, nowhere in the prior art are there seen shaped polycarbonate or copolymeric digital media discs that have been molded and are provided with an aperture in their outer periphery for hanging as an ornament with specialized hanging apparatus for hanging on a holiday tree or present, or on a peg, string, or hook. The prior art also does not show die, tool cut, punched Or molded polycarbonate or co polymeric media discs which have been utilized as the following items: CD or DVD: Christmas ornaments, gift gags, sports collector cords, collector cards, business cards and the like.

### SUMMARY OF THE INVENTION

The present invention consists of an improved molded shaped computer media storage disk having at least one aperture in its outer periphery which may be utilized to hang it on a tree or present/gift or peg, string, hook or as on ornament or gift tag. In this preferred embodiment, the CD or DVD Rom may be molded and shaped as an ornament or seasonal figurine such as a Christmas tree or Santa Clause and the like, depending upon the holiday or special occasion. In the case of a birthday, the CD Rom may contain a birthday song and be shaped like a birthday cake and used as an ornament. Or the CD disk may be shaped like a gift tag and hove a space provided to write in the name of the recipient and gift giver. These items have been typically router and CNC cut or loser cut to form their shape, and a molding process of creating the shape and outer periphery would greatly enhance the economy of making such articles.

Similarly, in yet an additional preferred embodiment of the present invention, the CD Rom or DVD Rom device may be shaped as a baseball, football or other collector's card, and the disk itself may contain an extensive history of the athlete with sports statistics and figures and it may further including numerous news articles, video clips and the like. It is intended that these products may be die cut, tool cut or loser cut from a round or shaped disk, or they may be molded in the desired shape.

Still yet an additional preferred embodiment of the present invention, when used as an ornament, it may be provided with a variety of hanging means and disk protection means. It is anticipated that a hook may be provided which is comprised of an interior wire which has been coated with a much softer outer coating on its exterior portion so as not to scratch the disk as it is being hung or removed from a Christmas Tree, a hook or peg, or other suitable hanging device. The hanger may also be decorative in fashion, as it may be made from soft plastic metallic chenille or other decorative materials. The computer media disk may have one or more apertures provided for a hook or decorative thread Where the disk is made in the form of a shaped ornament, it is anticipated that the disk has been molded to provide for an economical means of mass production.

In still yet an additional preferred embodiment of the present invention, a shaped digitized media disk is provided with a computer game contained therein and the shape and image utilized for the disk may be an image of the playing board or a playing piece or other item closely associated with playing of the particular game.

In yet a further anticipated preferred embodiment of the present invention, the computer media disk may be shaped in a rectangular or other form such that it resembles either a business card or a sports trading card. In the preferred embodiment where the disk is utilized as a sports trading cord, it is anticipated that the disk may be provided with detailed statistics regarding the history of the athlete, as well as news articles and even video clips of important moments in sports history. When the preferred embodiment is a business card, the computerized media may contain video commercials, statistics regarding the company, product and service information in both spreadsheet form and/or a DVD format. All of these discs may be sold and/or provided with a soft clingy film of plastic which allows the aesthetically pleasing features of the disk to be readily displayed, while at the same time, it prevents the disk from being scratched. Digital media discs are notorious for being damaged to the point that they will not work, even if just a few minor scratches or scrapes ore present on either surface of the disk. Accordingly, the discs must be handled and stored with core. When the discs are used as an ornament the need for protection is even greater.

### OBJECTS OF THE INVENTION

Thus, it is one primary object of the present invention to provide a computer media disk in a decorative shaped format which relates directly to the data contained thereon, and which has been economically formed by a molding process which creates at least one aperture in the out periphery of the disk.

It is yet an additional primary object of the present invention to provide a molded computer media disk in a decorative shaped format which has been provided with at least one aperture in its outer periphery for the purposes of hanging the decorative media disk upon a tree or present, peg, string, hook or other protrusion for an aesthetically pleasing effect, or for its use as a gift tag or ornament where space has been provided so the name of the gift giver and recipient may be written thereupon.

Another primary object of the present invention is to provide a computer media disk in a decorative shaped format such as a rectangle, and which has been imprinted with a picture of a sports figure, wherein the information contained in the media on the disk relates to athletic statistics and history pertaining to the sports figure, including news articles and video clips of the athlete's performances and which also may or may not have an aperture in its outer periphery.

Additionally, it is a primary object of the present invention to provide a shaped decorative computer media disk which resembles a business card and which has been provided with advertising and/or marketing information regarding that individual or the company that the individual is employed by, and which disk may or may not have been provided with an aperture in its outer periphery.

Still an additional primary object of the present invention is to provide a shaped digital media disk which may be utilized as a hanging ornament wherein the disk has further been provided with or without shaped clear, thin plastic sheeting which is clingy yet removable by peeling it away, such that the disk will retain its aesthetically pleasing appearance when used as an ornament and/or gift tag, yet problems due to damage will not occur.

Yet another primary object of the present invention is to provide a shaped digital media disk which has been provided with a computer game and the shape of the disk is a playing board, a figure from the game or a game board piece and which may or may not be provided with an aperture in its outer periphery.

Still a further primary object of the present invention is to provide a shaped digital media disk which has been molded and then either loser, punch or die cut, or tool cut to form a shape and outer aperture in its outer periphery.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a top elevational view of a shaped computer media disk showing the disk shaped as a Christmas tree figures with a Christmas tree image imprinted thereupon.

FIG. 2 is a top elevational view of a shaped computer media disk showing the disk shaped as a business card with business card information printed thereupon

FIG. 3 is a top elevational view of a shaped computer media disk showing cover with a protective plastic film that clings to the exterior of both sides of the disk so it may be hung and used as a decoration without fear that the disk will be damaged and become unusable where it is used as an ornament.

FIG. 4 is a top elevational view of a shaped computer media disk in the format of a sports card with an athlete's image and statistical synopsis printed thereupon.

FIG. 5 is a top elevational view of a shaped computer media disk in the format of a game playing piece which is representative of the type of computer game contained on the disk.

### DETAILED DESCRIPTION OF THE DRAWINGS

Shown in FIG. 1 is decorative shaped digital media disk 10 which has been provided with a Christmas tree image 12 printed thereupon. An aperture 14 has been provided in the outer periphery of the digital media disk 10 which is shaped to accommodate coated wire hook 16 which passes there through. By providing a coated wire hook 16 in lieu of a simple cord hanger, the disk may be hung securely upon a Christmas tree. It is notoriously difficult to securely hang and retain ornaments on live trees, but a wire hanger may be securely and easily formed by the user thereof to accommodate the exact shape and size of the tree branch which it may bear upon. In such a manner, the ornament will not dislodge when brushed up against or jarred by pets, children and the like. Of course an ornamental shaped digital media disk may further be provided with a space to write the gift giver's name and the recipient's name thereupon such that it may be utilized as a gift tag.

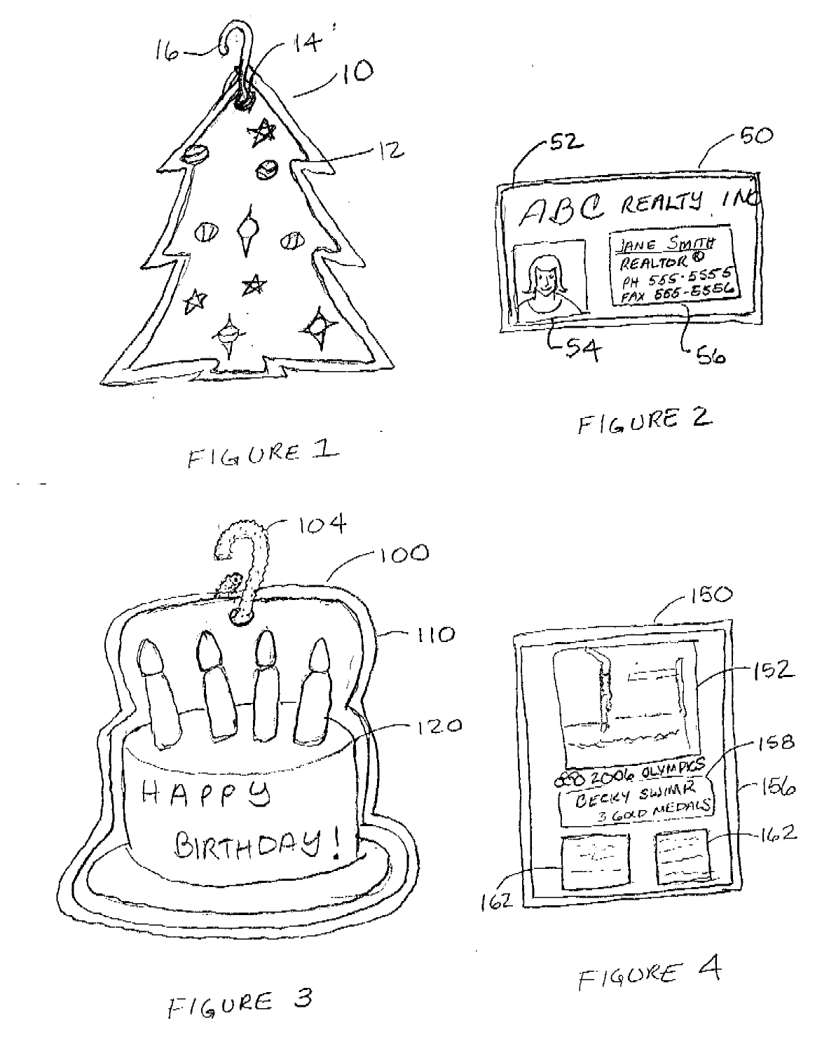

Shown in FIG. 2 is a decorative shaped digital media disk 50 which has been provided with the image of a business card 52. The digital media disk 50 shows the image of the individual 54, together with company name, address, phone, fox, website, and other pertinent information 56. The digital media disk 50 itself may contain some or all of the following: print and video advertisements, marketing materials, product and service information, company information and annual reports and the like. Realtors may desire to record home views and virtual tours for advertising purposes. Companies may wish to show their complete product lines, together with detailed reasons why their products are superior to the product lines of other companies. The discs may also show proper product use and maintenance. In such a manner, the media disk 50 provides a relatively inexpensive and efficient format upon which to provide basic information as well as detailed information regarding the product and services provided by a particular company.

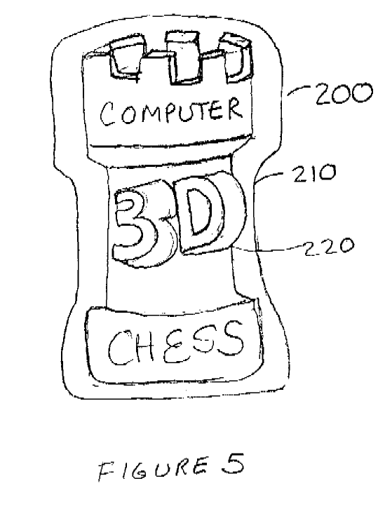

Shown in FIG. 3 is a decorative shaped digital media disk 100 which has been provided with a transparent covering of film 110 which clings to both sides of the disk. In this particular disk, digital media disk 100 is shaped like a birthday cake with candles and the image of a birthday cake with candles 120 appears imprinted thereupon. It is intended that the transparent film covering 110 may be easily and conveniently stripped away by the user to play the digital media disk 100 which may contain the birthday song, a song with special meaning, anecdotes of news occurrences from post years relating to the particular birth date, as well as a variety of interesting information of special interest to the recipient. Of course, the digital media disk 100 may be arranged such that the giver may burn a special song or message thereupon, depending if the giver has a with a CD and/or DVD burner or a microphone.

In this particular embodiment, chenille wire hanger 104 has been provided which has a very soft and cushiony exterior surface which may prevent scratching to digital media disk 100 when protective transparent film 110 is not used or has been or, or was simply not provided with the digital media disk 100.

FIG. 4 shows yet another preferred embodiment of the present invention, digital media disk 150, which shows athletic figure image 152, together with a brief synopsis of information relating to the highlights of the athletic figure's career 154. In this particular instance, digital media disk 150 has been produced in rectangular shape 156, but other shapes may also be utilized, such as football, golf ball, baseball bat, football goal, baseball home plate, etc., or a wide variety of non-circular shapes and forms. Digital media disk 150 has been imprinted with the athlete's name 158, and historical athletic information 162. Provided with appropriate coverings, they will be suitable for collecting by fans and securely retain a wide variety of information and data for many years to come. In this case, the athlete won gold medals at the Olympics, and such a card, since it is printed with a computer, may be printed in a relatively short period of time and sold at the sporting event, or by mail within a matter of days thereafter, making for a desirable keepsake. Or the card may be marketed from a mailing list for those persons who had attended the event.

FIG. 5 illustrates a further preferred embodiment of the present invention, digital media disk 200, which shows game playing piece shape 210, which has been imprinted with the game name and description 220, which contains a computerized version of a board game. In this case, the game is chess and the playing piece chosen was a castle or rook for dramatic effect. Of course, other computerized games which do not have corresponding board game versions may also be utilized. It is only important that a representative shape and image of items and things related to the actual game be used in the design of the digital media disk 200.

Each of the collecting cards, the business cards and the like may be made from a molding process wherein a mold is provided shaped to the final image of the digital media disk having on aperture in its outer periphery. Although numerous preferred embodiments of the present invention have been disclosed herein, the aperture provided for the purpose of hanging or securing the digital media disk is but one option. The digital media discs preferred embodiments disclosed herein may be constructed from utilizing a standard circular disk form and then shaping it by either punch cutting it, die cutting it or even cutting the disk with a tool. In the case of the ornaments and gift tags for holidays, the inventive process consists of molding them to produce the desired shapes and images on a mass production basis for economy in manufacture wherein a hanging aperture is created in the outer periphery of each disk.

I claim:

1. A method of producing a shaped digital media disk comprising the steps of;
providing a mold in an aesthetically pleasing non-circular shape wherein the mold will create at least one aperture in its outer periphery suitable for passing hanging means there through;
providing a quantity of molten copolymeric molding material;
filling the mold, allowing it to cool, and then removing the molding material therefrom to manufacture a media disk;
coating the media disk with material suitable for burning digitized data;
imprinting upon the media disk an aesthetically pleasing image;
embedding the media disk with digitized data.

2. The shaped digital media disk produced by the method of claim 1.

3. The shaped digital media disk of claim 2 wherein the molding material utilized is polycarbonate.

4. The shaped digital media disk of claim 2 further being provided with;
an exterior portion.
at least one sheet of substantially thin flexible sheet which may easily cling to the exterior portion to prevent damage to it.

5. The shaped digital media disk of claim 4 further being provided with hanging means.

6. The shaped digital media disk of claim 5 where the hanging means comprises a length of coated wire.

7. The shaped digital media disk of claim 5 where the hanging means comprises a length of chenille wire.

8. A method of producing a shaped digital media disk comprising the steps of;
providing a mold in an aesthetically pleasing shape other than circular;
providing a quantity of molten molding material;
filling the mold, allowing it to cool, and then removing the molding material therefrom to manufacture a media disk;
coating the digital media disk with material suitable for burning digitized data;
imprinting upon the digital media disk an aesthetically pleasing image;
embedding the media disk with digitized data.

9. The shaped digital media disk product produced by the method of claim 8.

10. The shaped digital media disk of claim 9 where the molding material is polycarbonate.

11. The shaped digital media disk of claim 9 further having the following items imprinted thereupon: an image of a person and athletic performance statistics.

10. The shaped digital media disk of claim 9 further having the following items imprinted thereupon: an image of a person and business contact information from one or more of the group consisting of: company name, phone number, fox number, email address, website address.

11. The shaped digital media disk of claim 2 which is further provided with both aural and visual data.

12. The shaped digital media disk of claim 9 which is further provided with both aural and visual data.

13. The shaped digital media disk of claim 9 which will allow a user thereof to burn aural and visual data thereupon.

14. The shaped digital media disk of claim 9 which will allow a user to burn aural and visual date thereupon.

13. The shaped media digital disk of claim 9 further having an image printed thereupon which has been selected from one or more of the following group of items; a game board, a game playing piece, a gaming character, or a musical cd.

14. The shaped media digital disk of claim 9 further having at least one computer game burned onto it.
